(19) United States
(12) Patent Application Publication
(10) Pub. No.: US 2024/0140203 A1
(43) Pub. Date: May 2, 2024

(54) Controller

(71) Applicant: TOYOTA JIDOSHA KABUSHIKI KAISHA, Toyota-shi Aichi-ken (JP)

(72) Inventors: Shingo ETO, Toyota-shi Aichi-ken (JP); Noritaka TAKUDA, Toyota-shi Aichi-ken (JP)

(73) Assignee: TOYOTA JIDOSHA KABUSHIKI KAISHA, Toyota-shi Aichi-ken (JP)

(21) Appl. No.: 18/385,031

(22) Filed: Oct. 30, 2023

(30) Foreign Application Priority Data
Nov. 1, 2022 (JP) 2022-175497

(51) Int. Cl. B60L 1/00; B60L 58/13

(52) U.S. Cl. CPC B60L 1/003; B60L 58/13; B60L 2240/547

(57) ABSTRACT

The controller is installed in the vehicle together with a motor for driving, an air conditioning unit for air conditioning the passenger compartment, auxiliary equipment, and a battery that supplies power to the motor, air conditioning unit, and auxiliary equipment. The controller is programmed to calculate the driving electricity cost based on the battery energy consumption integrated value, the integrated distance traveled, the air conditioning energy consumption integrated value, the auxiliary equipment energy consumption integrated value, and the positional energy variation of the vehicle during the trip, at the end of the trip. And then the controller is programmed to learn the driving learning electricity cost using the driving electricity cost, when the driving electricity cost is less than the threshold value.

### CROSS-REFERENCE TO RELATED APPLICATION

The present disclosure claims priority to Japanese Patent Application No. 2022-175497 filed on Nov. 1, 2022, which is incorporated herein by reference in its entirety including specification, drawings and claims.

### TECHNICAL FIELD

The present disclosure relates to a controller, and in particular, to a controller that is installed in a motor vehicle together with a motor, air conditioning unit, auxiliary equipment, battery, and the like.

### BACKGROUND

A controller of this type has been proposed that calculates the distance that can be traveled based on the vehicle's electric expenses and remaining battery capacity (see, for example, Patent Document 1). This controller calculates the electricity cost of the flat road using the value obtained by subtracting the resistance of the slope from the traveling resistance, and calculates the possible traveling distance on the flat road based on the electricity cost of the flat road and the remaining battery capacity. The controller then displays on the display the distance that can be traveled and the distance that can be traveled on a flat road.

### CITATION LIST

### Patent Literature

PTL1: JP2018-064329

### SUMMARY

The controller in the above-mentioned motor vehicle also learns the electricity cost of flat roads (driving electricity cost) using the electricity cost of flat roads obtained by calculation. Since the power output from the battery is also supplied to the air conditioning system and auxiliary equipment, the power consumption of the air conditioning system and auxiliary equipment must also be taken into account when calculating the running electricity cost. In addition, since the driving electricity cost varies greatly depending on whether the vehicle is towing or not, there are cases in which proper learning cannot be performed by using the driving electricity cost.

The main purpose of the controller of the present disclosure is to calculate the driving electricity cost more appropriately and to learn the driving electricity cost more appropriately.

The controller of the present disclosure has adopted the following to achieve the main objectives described above.

The controller of this disclosure is, the controller installed in a motor vehicle together with a motor for driving, an air conditioning unit for air conditioning the passenger compartment, auxiliary equipment, and a battery supplying power to said motor, said air conditioning unit, and said auxiliary equipment: wherein the controller is programmed to (A) calculate the driving electricity cost based on the battery energy consumption integrated value, the integrated distance traveled, the air conditioning energy consumption integrated value, the auxiliary equipment energy consumption integrated value, and the positional energy variation of the vehicle during the trip, at the end of the trip; and (B) learn the driving learning electricity cost using the driving electricity cost, when the driving electricity cost is less than the threshold value.

The controller of the present disclosure is installed in a motor vehicle together with a motor for driving, an air conditioning unit for air conditioning the passenger compartment, auxiliary equipment, and a battery that supplies power to the motor, air conditioning unit, and auxiliary equipment. At the end of a trip, the controller calculates the driving electricity cost based on the battery energy consumption integrated value, the integrated distance traveled, the air conditioning energy consumption integrated value, the auxiliary equipment energy consumption integrated value, and the positional energy variation of the vehicle during the trip. This allows more appropriate calculation of driving electricity costs. The controller then learns the driving learning electricity cost using the driving electricity cost, when the driving electricity cost is less than the threshold value. When the driving electricity cost is equal to or greater than the threshold value, the driving learning electricity cost is not learned, so the driving electricity cost can be learned more appropriately. The “threshold value” can be a value such as 3σ (three times standard deviation) from the average of the normal driving electricity cost. The driving learning electricity cost can be calculated by machine learning using the driving electricity cost calculated in the past, or by weighting the new driving electricity cost and the driving learning electricity cost resulting from previous learning. In this disclosure, “electricity cost” is defined to mean the amount of electricity used per unit distance traveled.

### BRIEF DESCRIPTION OF DRAWINGS

FIG. 1 shows a schematic diagram of an electric vehicle 20 equipped with a controller as an embodiment of the present disclosure.

FIG. 2 shows a flowchart of an example of the driving electricity cost learning process executed by the electronic control unit 60 of the embodiment.

### DETAILED DESCRIPTION OF EMBODIMENTS

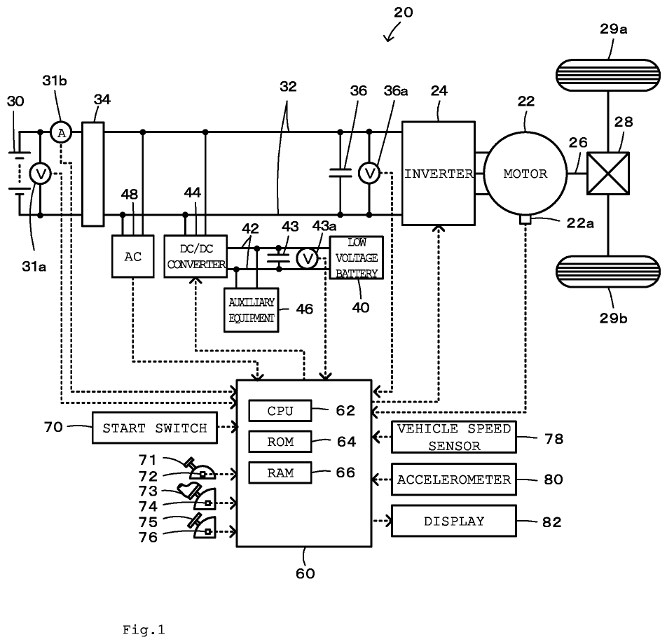

Next, the form for implementing this disclosure (embodiment) will be described. FIG. 1 shows a schematic diagram of an electric vehicle 20 equipped with a controller as an embodiment of the present disclosure. As shown in FIG. 1, the electric vehicle 20 of the embodiment includes a motor 22, an inverter 24, a high voltage battery 30, a low voltage battery 40, a DC/DC converter 44, auxiliary equipment 46, an air conditioning system 48, and an electronic control unit 60. The electronic control unit 60 in the embodiment corresponds to the “controller”.

The motor 22 is configured, for example, as a synchronous generator motor. The rotor of motor 22 (not shown) is connected to drive shaft 26, that is connected to the drive wheels 29a, 29b via differential gear 28. The motor 22 is equipped with a rotational position detection sensor 22a that detects the rotational position of the rotor.

The inverter 24 is composed as a well-known inverter circuit with six transistors and six diodes. The inverter 24 is connected to the high voltage system power line 32, which is connected to the high voltage battery 30. The inverter 24 converts DC power from the high voltage battery 30 to 3-phase AC through PWM control and applies to motor 22 to drive motor 22.

The high voltage battery 30 is composed of, for example, a lithium-ion battery. The high voltage battery 30 is connected to the high voltage system power line 32. The voltage sensor 31a, which detects the battery voltage Vb, is attached to both terminals of the high voltage battery 30. The current sensor 31b, which detects the battery current Ib, is attached to the terminals of the high voltage battery 30. The high voltage system power line 32 is fitted with the system main relay 34 that connects and disconnects the high voltage battery 30. The high voltage system power line 32 is also fitted with a smoothing capacitor 36. The high voltage system power line 32 is equipped with the voltage sensor 36a that detects the high voltage system voltage VH.

The low voltage battery 40 is composed of, for example, a lead-acid battery. The low voltage battery 40 is connected to the low voltage system power line 42. The auxiliary equipment 46 is attached to the low voltage system power line 42. Auxiliary equipment 46 may include wipers, lighting, seat heaters, steering wheel heaters, and so on. There is also the smoothing capacitor 43 attached to the low voltage system power line 42. There is the voltage sensor 43a attached to the low voltage system power line 42, which detects the low voltage system voltage VL.

The DC/DC converter 44 is connected to the high voltage system power line 32 and the low voltage system power line 42. The DC/DC converter 44 is constructed as a well-known DC/DC converter. DC/DC converter 44 supplies DC power from the high voltage system power line 32 to the low voltage system power line 42 by stepping down the DC power.

The electronic control unit 60 is constructed as a microcomputer with a CPU 62 as its core. The electronic control unit 60 includes a CPU 62 as well as ROM 64, RAM 66, flash memory (not shown), input ports (not shown), and output ports (not shown).

The electronic control unit 60 inputs the rotational position θ detected by rotational position detection sensor 22a, the battery voltage Vb detected by voltage sensor 31a, the battery current Ib detected by current sensor 31b, the high voltage system voltage VH detected by voltage sensor 36a, and the low voltage system voltage VL detected by voltage sensor 43a, etc. via input ports. The electronic control unit 60 inputs the start signal ST from start switch 70, the gas pedal opening Acc detected by the accelerator pedal position sensor 72 attached to the accelerator pedal 71, the brake pedal position BP detected by the brake pedal position sensor 74 attached to the brake pedal 73, and the shift position SP detected by the shift lever position sensor 76 attached to the shift lever 75. The electronic control unit 60 also inputs the vehicle speed V detected by the vehicle speed sensor 78 and the acceleration a detected by the accelerometer 80. The electronic control unit 60 also inputs the power consumption Wac of the air conditioning system 48.

The electronic control unit 60 outputs switching control signals to the inverter 24, drive control signals to the DC/DC converter 44, and display control signals to the display 82 via output ports.

The electronic control unit 60 calculates the rotation speed Nm of the motor 22 based on the rotational position θ of the rotor of the motor 22. The electronic control unit 60 calculates the storage ratio SOC of the high voltage battery 30 based on the integrated value of the battery current Ib.

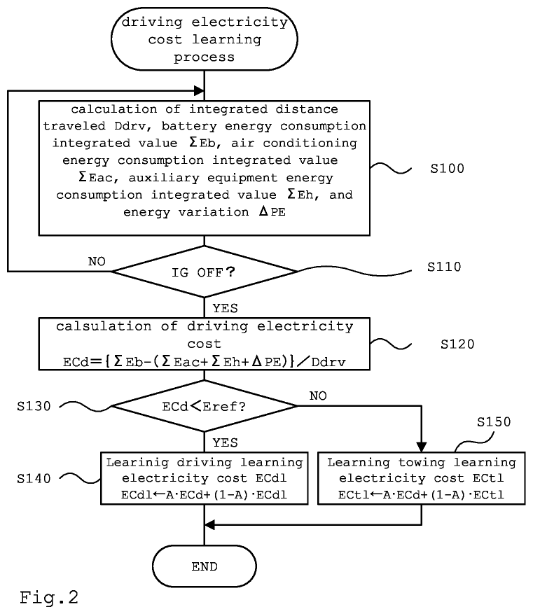

Next, the operation of the electric vehicle 20 of the embodiment, especially the operation of the electronic control unit 60 in predicting the electricity cost over the estimated driving distance, will be described. FIG. 2 shows a flowchart of an example of the driving electricity cost learning process executed by the electronic control unit 60 of the embodiment. In the embodiment, “electricity cost” is assumed to mean the amount of electricity used per unit mileage.

In the running electricity cost learning process, the electronic control unit 60 performs the following calculations until the start switch 70 is turned off (ignition off: IG off) (steps S100, S110). The electronic control unit 60 calculates the integrated distance traveled Ddrv until the trip is completed. The electronic control unit 60 calculates the integrated amount of energy discharged from the high voltage battery 30 (the battery energy consumption integrated value ΣEb) until the trip is completed. The electronic control unit 60 calculates the integrated power consumption of the air conditioning system 48 (the air conditioning energy consumption integrated value ΣEac) until the trip is completed. The electronic control unit 60 calculates the integrated power consumption of the auxiliary equipment 46 (the auxiliary equipment energy consumption integrated value ΣEh) until the trip is completed. The electronic control unit 60 calculates the change in position energy of the electric vehicle 20 (the positional energy variation ΔPE) until the trip is completed.

Next, the electronic control unit 60 calculates the driving electricity cost ECd (step S120). The driving electricity cost ECd can be calculated by subtracting the sum of the air conditioning energy consumption integrated value ΣEac, the auxiliary equipment energy consumption integrated value ΣEh, and the position energy variation ΔPE from the battery energy consumption integrated value ΣEb, and then dividing the result by the integrated distance traveled Ddrv.

The electronic control unit 60 then determines whether the driving electricity cost ECd is less than the threshold value Eref or not (step S130). The threshold value Eref is a threshold value that determines whether or not to learn the driving electricity cost ECd, and can be, for example, a value that takes into account 3σ (three times standard deviation) from the average value of the driving electricity cost ECd.

The electronic control unit 60 determines that the driving electricity cost ECd is less than the threshold value Eref in step S130, the electronic control unit 60 learns the driving learning electricity cost ECdl using the driving electricity cost ECd (step S140) and terminates the process. The driving learning electricity cost ECdl can be calculated, for example, as the sum of the driving electricity cost ECd multiplied by the weight A and the sum of previous the driving learning electricity cost ECdl multiplied by (1−A). The driving learning electricity cost ECdl may also be calculated by machine learning using the driving electricity cost ECd and the driving electricity cost ECd below the historical threshold value Eref. Thus, by learning the driving learning electricity cost ECdl when the driving electricity cost ECd is less than the threshold value Eref, the driving learning electricity cost ECdl can be learned more appropriately.

When the electronic control unit 60 determines that the driving electricity cost ECd is equal to or greater than the threshold value Eref in step S130, the electronic control unit 60 learns the towing learning electricity cost ECtl using the driving electricity cost ECd (step S150), and terminates this process. The towing learning electricity cost ECtl can be calculated, for example, as the sum of the driving electricity cost ECd multiplied by the weight A and the towing learning electricity cost ECtl up to now multiplied by (1−A). The towing learning electricity cost ECtl may be calculated by machine learning using the driving electricity cost ECd and the driving electricity cost ECd that has been equal to or greater than the threshold Eref in the past. Thus, the towing learning electricity cost ECtl is learned when the driving electricity cost ECd is equal to or greater than the threshold value Eref, the learning of the towing learning electricity cost ECtl can be performed more appropriately. The towing learning electricity cost ECtl is the electricity cost when the electric vehicle 20 is towing a trailer or other vehicle. Therefore, in the embodiment, the threshold value Eref is the threshold that determines whether the driving learning electricity cost ECdl is learned or towing learning electricity cost ECtl is learned.

The electronic control unit 60 can, if necessary, display the driving electricity cost ECd, the driving learning electricity cost ECdl, and towing learning electricity cost ECtl on display 82.

In the electronic control unit 60 installed in the electric vehicle 20 of the embodiment described above, during a trip, the integrated distance traveled Ddrv, the battery energy consumption integrated value ΣEb, the air conditioning energy consumption integrated value ΣEac, the auxiliary equipment energy consumption integrated value ΣEh, and the positional energy variation APE are calculated. When the trip has been completed, the electronic control unit 60 calculates the driving electricity cost ECd based on the integrated distance traveled Ddrv, the battery energy consumption integrated value ΣEb, the air conditioning energy consumption integrated value ΣEac, the auxiliary equipment energy consumption integrated value ΣEh, and the positional energy variation ΔPE. The electronic control unit 60 also uses the air conditioning energy consumption integrated value ΣEac, the auxiliary equipment energy consumption integrated value ΣEh, the positional energy variation ΔPE to calculate the driving electricity cost ECd, so the driving electricity cost ECd can be calculated more appropriately.

When the electronic control unit 60 installed in the electric vehicle 20 of the embodiment determines that the driving electricity cost ECd is less than the threshold value Eref, the electronic control unit 60 learns the driving learning electricity cost ECdl using the driving electricity cost ECd. This makes the learning of the driving learning electricity cost ECdl more efficient than learning the driving learning electricity cost ECdl when it is determined that the driving electricity cost ECd is less than the threshold value Eref. When the electronic control unit 60 of the implementation determines that the driving electricity cost ECd is equal to or greater than the threshold value Eref, the electronic control unit 60 learns the towing learning electricity cost ECtl using the driving electricity cost ECd. This allows for more appropriate learning of the towing learning electricity cost ECtl.

In the electronic control unit 60 installed in the electric vehicle 20 of the embodiment, when the driving electricity cost ECd is determined to be equal to or greater than the threshold value Eref, the towing learning electricity cost ECtl is learned using the driving electricity cost ECd. However, when the electronic control unit 60 determines that the driving electricity cost ECd is equal to or greater than the threshold value Eref, the electronic control unit 60 may not learn the towing learning electricity cost ECtl.

In the electronic control unit 60 installed in the electric vehicle 20 of the embodiment, if necessary, the driving electricity cost ECd, the driving learning electricity cost ECdl, and the towing learning electricity cost ECtl are displayed on the display 82. However, the electronic control unit 60 may not displays the driving electricity cost ECd, the driving learning electricity cost ECdl, and towing learning electricity cost ECtl on display 82.

In the controller of the present disclosure, the controller may be programmed to learn the towing learning electricity cost using the driving electricity cost when the driving electricity cost is equal to or greater than the threshold value. In this way, the towing learning electricity cost can be learned more appropriately. The towing learning electricity cost can be calculated by machine learning using the driving electricity cost equal to or greater than the threshold value calculated in the past, or by weighting the new driving electricity cost equal to or greater than the threshold value and the towing learning electricity cost resulting from previous learning.

In the controller of the present disclosure, the controller may be programmed to calculate the driving electricity cost that calculated by subtracting the sum of the air conditioning energy consumption integrated value, the auxiliary equipment energy consumption integrated value, and the position energy variation from the battery energy consumption integrated value, and then dividing the result by the integrated distance traveled.

The following is an explanation of the correspondence between the main elements of the embodiment and the main elements of the present disclosure described in the Summary section. In the embodiment, motor 22 corresponds to “motor”, air conditioning unit 48 corresponds to “air conditioning unit”, auxiliary unit 46 corresponds to “auxiliary unit”, high voltage battery 30 corresponds to “battery”, and electronic control unit 60 corresponds to “controller”.

The correspondence between the major elements of the embodiment and the major elements of the present disclosure described in the Summary section is an example of how the embodiment can be used to specifically explain the embodiment of the present disclosure described in the Summary section. This does not limit the elements of the present disclosure described in the Summary section. In other words, interpretation of the invention described in the Summary section should be based on the description in that section, and the embodiment is only one specific example of the present disclosure described in the Summary section.

The above is a description of the form for implementing this disclosure using the embodiment. However, the present disclosure is not limited in any way to these embodiments, and can of course be implemented in various forms within the scope that does not depart from the gist of the present disclosure.

### INDUSTRIAL APPLICABILITY

This disclosure is applicable to the manufacturing industry for controllers installed in motor vehicles and other applications.

1. A controller installed in a motor vehicle together with a motor for driving, an air conditioning unit for air conditioning a passenger compartment, an auxiliary equipment, and a battery supplying power to the motor, the air conditioning unit, and the auxiliary equipment:
wherein the controller is programmed to
(A) calculate a driving electricity cost based on a battery energy consumption integrated value, an integrated distance traveled, an air conditioning energy consumption integrated value, an auxiliary equipment energy consumption integrated value, and an positional energy variation of the vehicle during a trip, at an end of the trip; and
(B) learn a driving learning electricity cost using the driving electricity cost, when the driving electricity cost is less than a threshold value.

2. The controller according to claim 1,
wherein the controller is programmed to learn a towing learning electricity cost using the driving electricity cost when the driving electricity cost is equal to or greater than the threshold value.

3. The controller according to claim 1,
wherein the controller is programmed to calculate the driving electricity cost by subtracting a sum of the air conditioning energy consumption integrated value, the auxiliary equipment energy consumption integrated value, and the position energy variation from the battery energy consumption integrated value, and then dividing a result by the integrated distance traveled.

4. The controller according to claim 2,
wherein the controller is programmed to calculate the driving electricity cost by subtracting a sum of the air conditioning energy consumption integrated value, the auxiliary equipment energy consumption integrated value, and the position energy variation from the battery energy consumption integrated value, and then dividing a result by the integrated distance traveled.
